(19) United States
(12) Patent Application Publication
(10) Pub. No.: US 2023/0145350 A1
(43) Pub. Date: May 11, 2023

(54) Comfort Element for a Vehicle and Comfort Arrangement

(71) Applicant: Mercedes-Benz Group AG, Stuttgart (DE)

(72) Inventors: Matthias ULMER, Rottenburg (DE); Thorsten JOOS, Schlierbach (DE); Alexander STERN, Dettenhausen (DE)

(21) Appl. No.: 17/916,312

(22) PCT Filed: Feb. 12, 2021
(86) PCT No.: PCT/EP2021/053418

§ 371 Date: Sep. 30, 2022

(30) Foreign Application Priority Data
Apr. 1, 2020 (DE) 10 2020 108 996.1

(51) Int. Cl. B60N 2/90

(52) U.S. Cl. CPC B60N 2/976; B60N 2/914; B60N 2/995

(57) ABSTRACT

A comfort element for a vehicle includes an actuator for carrying out a comfort function, a comfort-element-internal store configured to drive the actuator and/or a coupling device for coupling to a comfort-element-external store configured to drive the actuator. The comfort element further includes a data interface for coupling to an operating unit.

### BACKGROUND AND SUMMARY OF THE INVENTION

The invention relates to a comfort element for a vehicle.

The invention further relates to a comfort arrangement.

DE 10 2010 055 596 A1 describes a seat system for a motor vehicle with an associated cushion for a neck and shoulder region of a seat occupant. The cushion is connected to the seat system via a connecting line, wherein the cushion can be removed from the seat system and the connecting line is separable in the region of a contact point.

Furthermore, a foot comfort device for motor vehicles for placement in the floor region in front of a motor vehicle seat and for resting and supporting a foot of a vehicle occupant is known from DE 10 2013 000 947 A1, wherein the foot comfort device has a cushion-like or pad-like main body and a massage device which is designed in such a way that the massage function can be controlled via a vehicle network. For this purpose, the foot comfort device has a connection for connecting to the vehicle network and a massage program that can be executed by the massage device.

The object of the invention is to provide an improved comfort element for a vehicle and an improved comfort arrangement compared to the prior art.

The comfort element for a vehicle according to the invention comprises at least one actuator for executing a comfort function, at least one comfort-element-internal store set up to drive the at least one actuator and/or at least one coupling device for coupling to at least one comfort-element-external store set up to drive the at least one actuator, as well as at least one data interface for coupling with an operating unit.

The configuration of the comfort element allows it to be subsequently integrated into a vehicle and, if necessary, retrofitted without conversion work and to be removed from a vehicle in a simple manner in order to be used outside the vehicle, for example in a home area, an office area, a workplace or any other areas. The presence of the comfort-element-internal store and/or the at least one coupling device also contributes to this. Due to the data interface, the comfort element can be operated in a vehicle with integration in an existing vehicle infrastructure and can be operated, for example, via a so-called head unit of the vehicle. This allows a user to operate the comfort element with operating elements already present in the vehicle, so that operation can be carried out in the usual way, intuitively, and safely. Due to the data interface, the comfort element can also be operated additionally outside the vehicle and, for example, via an application program, also referred to as an app, of a mobile terminal, for example a mobile phone, tablet computer, personal computer, laptop or so-called wearables. This allows a user to operate the comfort element using existing operating units without the need for a separate operating element. For example, it is possible to integrate a control function into a vehicle manufacturer's own application program.

In one possible embodiment of the comfort element, it comprises at least one control unit, for example a microcontroller, for controlling the at least one actuator. Thus, there is no need for an in-vehicle control unit for operating the comfort element in the vehicle or for a control unit arranged externally of the vehicle and comfort element for operating the comfort element outside the vehicle. This results in a further simplification of integration and, if necessary, retrofitting of the comfort element in a vehicle and a further simplification of use of the comfort element outside the vehicle.

In another possible embodiment of the comfort element, it comprises a reversible and non-destructively detachable fastening device for mechanical fastening to a structure. This allows, on the one hand, a secure fastening of the comfort element to a structure formed inside or outside the vehicle, for example a seat element, in a predetermined position and, on the other hand, easy detachment from this structure. The fastening device comprises, for example, a clip, a bracket, a latch, a snap fastener, a push button and/or other suitable fastening structures.

In another possible embodiment of the comfort element, the actuator for generating the comfort function is mechanically movable and/or can be supplied with at least one working fluid. This makes it possible, for example, to perform the comfort function by means of an electrically operated actuator and/or an actuator that can be filled with a working fluid, for example a gas or a liquid.

In a further possible embodiment of the comfort element, the at least one comfort-element-internal store comprises an energy store and/or a working fluid store and thus allows operation of the comfort element even when it is disconnected from a mains store, for example an electrical mains.

In another possible embodiment of the comfort element, the data interface is set up for wireless and/or wired coupling to the operating unit. A wireless coupling is carried out, for example, in accordance with the IEEE 802.11 standard. This allows a simple, secure coupling of the comfort element to an operating unit that can be universally implemented in a large number of application areas. For example, the data interface is part of the control unit, wherein the control unit forms, for example, a web server, in particular a radio web server with a radio interface.

In a further possible embodiment of the comfort element, the coupling device is set up for wireless and/or wired coupling to the at least one comfort-element-external store. This allows a simple, secure coupling of the comfort element to a comfort-element-external store, which can be carried out universally in a large number of application areas.

In another possible embodiment of the comfort element, the at least one actuator is set up to perform a massage function and/or a heating function and/or a cooling function as a comfort function. Thus, a user's well-being can be effectively increased.

The comfort arrangement according to the invention comprises at least one comfort element as described above and at least one operating unit for operating the comfort element.

The configuration here of the comfort element allows it to be subsequently integrated into the comfort arrangement, for example a vehicle, and, if necessary, retrofitted without any conversion work and removed from a vehicle in a simple manner in order to be used outside the vehicle, for example in a comfort arrangement formed as a home area, office area, workplace or any other area.

In one possible embodiment of the comfort arrangement, at least one operating unit is a mobile terminal and/or at least one operating unit of a vehicle. Operation of the comfort element via an operating unit in the form of a mobile terminal, for example a mobile phone, tablet computer, personal computer, laptop or so-called wearable, in particular operation via an application program, also referred to as an app for short, of the mobile terminal, allows a user to operate the comfort element using existing operating units without the need for a separate operating element. The operation of the comfort element via an operating unit of a vehicle, for example a so-called head unit, allows a user to operate the comfort element in the usual way, intuitively and safely.

In a further possible embodiment of the comfort arrangement, it comprises at least one comfort-element-external store for driving the at least one actuator of the at least one comfort element, which store comprises at least one energy store and/or at least one working fluid store and/or at least one mains store. On the one hand, this allows the actuator to be supplied with energy and/or a working medium by coupling the comfort-element-external store to the coupling device of the comfort element and, on the other hand, to be charged if a comfort-element-internal store is present, so that operation of the comfort element is still possible if it is separated from the comfort-element-external store.

Exemplary embodiments of the invention will be explained in greater detail below with reference to drawings.

### BRIEF DESCRIPTION OF THE DRAWINGS

FIG. 1 is a schematic perspective view of a comfort arrangement; and

FIG. 2 is a schematic block diagram of a comfort arrangement.

### DETAILED DESCRIPTION OF THE DRAWINGS

Corresponding parts are provided with the same reference signs in all figures.

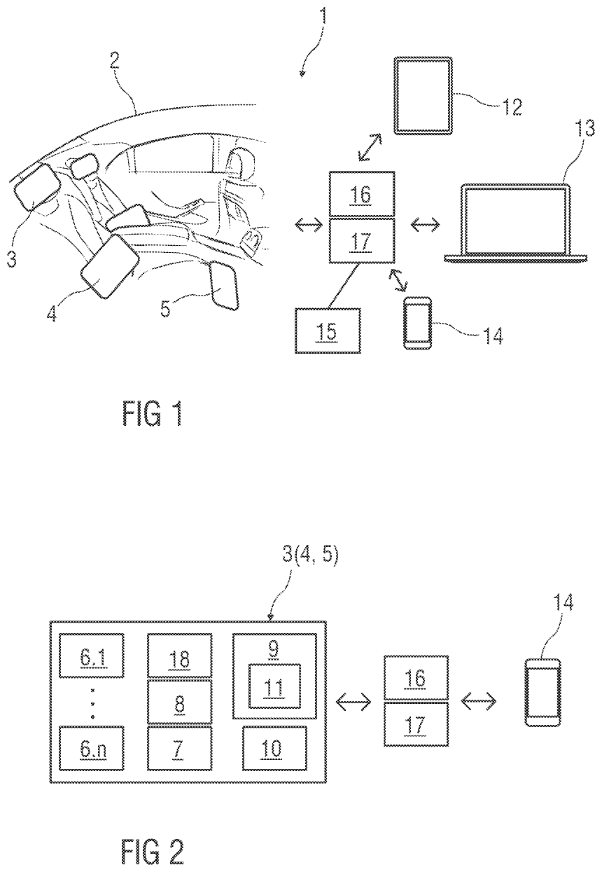

FIG. 1 shows a perspective view of a possible exemplary embodiment of a comfort arrangement 1, wherein the comfort arrangement 1 is formed in a vehicle 2. FIG. 2 shows a block diagram of another possible exemplary embodiment of such a comfort arrangement 1.

The comfort arrangement 1 comprises, for example, three comfort elements 3, 4, 5 which can be arranged in a vehicle rear, in exemplary embodiments not shown also in other vehicle regions, wherein a first comfort element 3 is, for example, a neck cushion with a massage and/or heating function, a second comfort element 4 is a cushion with a massage and/or heating function, and a third comfort element 5 is a calf support with a massage and/or heating function. In an embodiment not shown in greater detail, the comfort arrangement 1 can also have further comfort elements 3, 4, 5 or a smaller number of comfort elements 3, 4, 5.

The comfort elements 3, 4, 5 comprise here at least one actuator 6.1 to 6.n, in the shown exemplary embodiments a plurality of actuators 6.1 to 6.n, wherein each actuator 6.1 to 6.n is set up to perform a comfort function. For example, at least one of the actuators 6.1 to 6.n is a vibration motor for performing a mechanically generated movement for generating a massage function. For example, alternatively or additionally, at least one of the actuators 6.1 to 6.n can be acted upon by a working fluid, for example a gas or a liquid, to execute a movement for generating a massage function. For example, such an actuator 6.1 to 6.n is formed as a fillable bladder or as a fillable balloon. For example, alternatively or additionally at least one of the actuators 6.1 to 6.n is formed as a heating device for performing a heating function. For example, alternatively or additionally at least one of the actuators 6.1 to 6.n is formed as a cooling device for performing a cooling function.

The comfort element 5 formed as a calf support or calf rest is designed, for example, to perform a calf massage for a vehicle occupant and can be positioned in a corresponding region in the vehicle 2. To carry out this calf massage, the calf support comprises in particular a plurality of actuators 6.1 to 6.n formed as vibration motors.

The comfort elements 3, 4, 5 are formed here in such a way that they can be subsequently integrated and, if necessary, retrofitted into a vehicle 2 without any conversion work and can be removed from the vehicle 2 in a simple manner in order to be used outside the vehicle, for example in a home area, an office area, a workplace or any other areas.

In order to make this possible, the comfort elements 3, 4, 5 each comprise at least one comfort-element-internal store 7 set up to drive the at least one actuator 6.1 to 6.n. Depending on the design and function of the corresponding actuator 6.1 to 6.n, this store 7 comprises an energy store, for example an electric accumulator, and/or a working fluid store. Alternatively or additionally, the comfort elements 3, 4, 5 each comprise at least one coupling device 8 for wireless and/or wired coupling to at least one comfort-element-external store, for example an energy store, for example an electric accumulator, and/or at least one working fluid store, for example a gas and/or liquid store, and/or at least one mains store, for example an electrical mains, set up to drive the at least one actuator 6.1 to 6.n. For example, the coupling device 8 can comprise a charging unit and/or a power supply unit, by means of which an electrical charging of the comfort-element-internal store 7, in particular both in the vehicle 2 and in an area located outside the vehicle 2, and/or a direct operation of the at least one actuator 6.1 to 6.n is possible. For example, such a charging unit and/or such a power supply unit can be coupled to a mains store or the vehicle 2 by means of a conventional mains plug. In this case, the mains plug can be an integral part of the particular comfort element 3, 4, 5. For example, the coupling device 8 can alternatively or additionally also comprise a pneumatic and/or hydraulic connection for supplying an actuator 6.1 to 6.n operable with a working fluid.

Furthermore, the comfort elements 3, 4, 5 for independent execution of the comfort functions inside the vehicle 2 and outside the same comprise in particular in each case at least one control unit 9 for controlling the at least one actuator 6.1 to 6.n. In this case the control can be effected directly or indirectly, for example by corresponding control of a driver circuit 10, for example a motor driver, if the actuator 6.1 to 6.n comprises an electric motor. The control unit 9 is formed as a microcontroller, for example.

Furthermore, the comfort elements 3, 4, 5 for independent execution of the comfort functions inside the vehicle 2 and outside the same comprise in particular at least one data interface 11 for wireless and/or wired coupling to at least one operating unit 12 to 15. The data interface 11 is for example a component of the control unit 9, wherein the control unit 9 forms for example a web server, in particular a radio web server with a radio interface. With such a configuration of the radio interface, a coupling of an operating unit 12 to 15 can take place, for example in accordance with the IEEE 802.11 standard, forming a radio connection 16. If the data interface 11 is configured for a wired coupling to an operating unit 12 to 15, a wired connection 17 is created.

The operating units 12 to 14 are formed as mobile terminals and are provided, for example, for operating the comfort elements 3, 4, 5 in an area outside the vehicle 2. For example, the operating unit 12 is a tablet computer, the operating unit 13 is a laptop, and the operating unit 14 is a mobile phone, for example a smartphone. The comfort elements 3, 4, 5 are operated here in particular via a user interface, voice input and/or gesture input of an application program, also referred to as an app for short, installed on the relevant operating unit 12 to 14. The application program can be a vehicle manufacturer's own application program.

The operating unit 15 is an operating unit of the vehicle 2, for example a so-called head unit of the vehicle 2.

In order to allow a secure fastening of the comfort elements 3, 4, 5 to a structure formed inside the vehicle 2 or outside the vehicle 2, for example a seat element, in a predetermined position and, on the other hand, an easy detachment from this structure, the comfort elements 3, 4, 5 each comprise, for example, a reversible and non-destructively detachable fastening device 18, which comprises, for example, a clip, a bracket, a latch, a snap fastener, a push button and/or other suitable fastening structures.

1-10. (canceled)

11. A comfort element for a vehicle, comprising:
an actuator for carrying out a comfort function;
a comfort-element-internal store configured to drive the actuator and/or a coupling device for coupling to a comfort-element-external store configured to drive the actuator; and
a data interface for coupling to an operating unit.

12. The comfort element according to claim 11, further comprising a control unit for controlling the actuator.

13. The comfort element according to claim 11, further comprising a reversibly and non-destructively detachable fastening device for mechanical fastening to a structure.

14. The comfort element according to claim 11, wherein the actuator is mechanically movable and/or can be acted upon by a working fluid in order to generate the comfort function.

15. The comfort element according to claim 11, wherein the comfort-element-internal store comprises an energy store and/or a working fluid store.

16. The comfort element according to claim 11, wherein the data interface is configured for wireless and/or wired coupling to the operating unit.

17. The comfort element according to claim 11, wherein the coupling device is configured for wireless and/or wired coupling to the comfort-element-external store.

18. A comfort arrangement, comprising:
the comfort element according to claim 11; and
an operating unit for operating the comfort element.

19. The comfort arrangement according to claim 18, wherein the operating unit is a mobile terminal or an operating unit of a vehicle.

20. The comfort arrangement according to claim 18, further comprising a comfort-element-external store configured to drive the actuator of the comfort element, wherein the comfort-element-external store comprises an energy store and/or a working fluid store and/or a mains store.
